(19) United States
(12) Patent Application Publication
(10) Pub. No.: US 2013/0189634 A1
(43) Pub. Date: Jul. 25, 2013

(54) PLANT AND METHOD FOR PREHEATING BLANKS IN RESPONSE TO HOT FORMING

(71) Applicant: Matthias Bors, Taufkirchen (DE)

(72) Inventor: Matthias Bors, Taufkirchen (DE)

(21) Appl. No.: 13/707,646

(22) Filed: Dec. 7, 2012

(30) Foreign Application Priority Data
Dec. 8, 2011 (DE) 10 2011 120681.0

(51) Int. Cl. F27B 9/12; F27B 9/36; C21D 1/52; F27B 9/20

(52) U.S. Cl. CPC F27B 9/12; F27B 9/20; F27B 9/36; C21D 1/52
USPC 432/11; 432/146; 432/239

(57) ABSTRACT

A plant for hot forming blanks includes at least one preheating device, and at least one main heating device arranged downstream from the at least one preheating device. The preheating device includes at least one pre-mixing burner which is selected from a hydrogen-oxygen burner, a fuel gas-oxygen burner and an acetylene burner. A related preheating device and method are also provided.

### BACKGROUND OF THE INVENTION

The invention relates to a plant for hot forming blanks, to a device for preheating the blanks for such a plant as well as to corresponding methods for hot forming and preheating.

The hot forming of metal sheets is a relatively new development trend in the component manufacturing, in particular for vehicle bodies. In the context of this application, following the well-established language use in the field of shaping technology, metal sheets used hereby are accordingly also identified as “blanks”. In principle, a blank is a correspondingly cut, die cut, joined and/or preformed metal sheet.

The hot forming makes it possible to produce components comprising a high stability and a complex geometry without resilience and allows for a significant weight reduction in the case of the auto bodies manufactured therewith, e.g., as well as for an increase of safety, for example of passengers of a corresponding vehicle.

With the increasing demands of stability and stiffness of structure components, in particular in the vehicle, high-strength and highest-strength steels are used increasingly. An increase of the stability provides for a reduction of the vehicle weight, which provides in particular for a reduced pollutant emission and fuel consumption. In the case of current vehicle models, the use of hot formed components can save up to 25 kg of weight.

In essence, hot forming methods are combined forming, hardening and tempering techniques. By using corresponding steels, such as manganese-boron steels, for example, stabilities of more than 1,500 MPa can be reached therewith. Press-hardening methods comprise, for example, the heating of blanks to a temperature, which lies above the complete austenitization temperature, e.g. above 850° C., and the subsequent quick cool-down of the blank in the tool. The desired martensitic structure comprising the desired stability is formed through this. The combination of the forming with the quenching in a tool is occasionally also identified as press- or form-hardening.

In principle, so-called roller hearth furnaces are used for preheating the blanks in response to the hot forming of highest-strength materials for car bodies. The heating of such furnaces typically takes place by means of steel pipes, which are heated electrically or by means of gas burners. To attain process cycle times, which are as short as possible, a certain “supply” of preheated components is necessary in the plant. The heat treatment duration for the temperature control of the steel represents a significant parameter, which defines the clock cycle of a corresponding press. However, due to the low degree of efficiency at temperatures of below 600°, the efficiency of roller hearth furnaces is small. Roller hearth furnaces encompass a length of up to 50 meters and thus require corresponding structural conditions, including an efficient dissipation of excess heat. Drum melting furnaces, which are used as an alternative to roller hearth furnaces, to preheat components, also encompass corresponding disadvantages. They are also heated by means of steel pipes and are unsatisfactory in view of their degree of efficiency.

Press-hardened components are characterized by their high stability and stiffness. As mentioned, metal sheet thicknesses can be reduced through this and weight can thus be saved.

There is thus a need for improved and more efficient possibilities for preheating corresponding blanks prior to the hot forming. With the use of modern pressing tools, the cycle time of the pressing process can be reduced considerably. The element, which defines the entire cycle time, is oftentimes no longer the pressing tool, but the heat treatment process.

### OBJECT OF THE INVENTION

It is thus the object of the instant invention to specify a method and a device which allow for an acceleration of a heat treatment process, in particular for a quicker austenitization of blanks.

### BRIEF DESCRIPTION OF THE DRAWINGS

FIG. 1 shows a plant for hot forming blanks according to an embodiment of the invention in a schematic illustration.

FIG. 2 shows burner heads for being used according to the state of the art and according to an embodiment of the invention, respectively, in a schematic illustration.

FIG. 3 shows a method for hot forming blanks according to an embodiment of the invention in the form of a flow chart.

### DESCRIPTION OF THE INVENTION

In view of the above, the instant invention proposes a plant for hot forming blanks, a device for preheating the blanks for such a plant as well as corresponding methods for hot forming and preheating comprising the features of the independent patent claims. Preferred embodiments are the subject matter of the subclaims as well as of the following description.

The measures proposed according to the invention provide the preheating device with at least one fuel-oxygen burner, hydrogen-oxygen burner or acetylene burner in a plant for hot forming blanks having at least one preheating device and at least one main heating device, which is arranged downstream from the at least one preheating device, in particular an austenitization device. The term acetylene-burner is to include acetylene-oxygen burners and acetylene-air burners.

As mentioned above, the term “blanks” in the context of this application shall be understood in a comprehensive manner. The term includes metal sheets, semifinished parts, joined and/or preformed components, which are hot formed, in particular press-hardened, in a corresponding plant.

The measures according to the invention, however, cannot only be used in the case of correspondingly prepared metal sheets, but also in the case of the respective used base materials. The invention thus extends to all workpieces or semifinished parts, respectively, which can be formed in a corresponding forming process, for example by means of pressing and/or deep-drawing.

It is particularly advantageous to use pre-mixing burners. Such burner types are known from DE 103 54 411 A1, for example. For example, pre-mixing fuel gas-oxygen burners are used for the so-called flame polishing of glass parts, in particular parts made of lead crystal. At least a part of the surface of the glass part is hereby heated and melted by means of the burner flame. Corresponding burners are also known as HYDROPOX™ burners and are distributed under this brand name by The Linde Group.

Pre-mixing fuel gas-oxygen burners, in particular hydrogen-oxygen burners, are characterized by a particularly high heat transfer efficiency. Contrary to so-called externally-mixing burners, a gas mixture of fuel gas and oxygen is already supplied to a burner head of a pre-mixing fuel gas-oxygen burner, instead of being generated first in a corresponding burner head. Pre-mixing burners generate particularly hard flames, which are suitable to melt larger surface areas, which can also encompass depressions or other irregularities. As was brought to light according to the invention, this represents a significant advantage as compared to externally-mixing burners. Only a soft flame, which cannot permeate in particular into corners, holes or depressions of a surface, can be generated in externally-mixing burners. Even though it would also be possible to reach corresponding temperatures by heating by means of an externally-mixing burner for a longer period of time, there is a risk thereby that the blank heats up irregularly.

For locally heating the blanks, it turned out to be advantageous to provide for a burner having a plurality of nozzle openings, from which the fuel-oxygen or the hydrogen-oxygen mixture or the acetylene-air or acetylene-oxygen mixture escapes. In a preferred embodiment, the burner has between 100 and 1000 nozzle openings. A highly continuous heating of the region, which is to be heated, is attained in this manner.

The nozzle openings are distributed to an area of the burner head, which has a width of between 50 and 400 mm. The area of the burner or of the burner head, respectively, which is covered by the nozzle openings, is preferably chosen as a function of the size of the regions, which are to be heated.

Advantageously, the burner has a plurality of nozzle openings, which are arranged close to one another, and have a relatively small diameter. A highly continuous heating of the blanks or of the regions of the blanks, which are to be heated, respectively, can be attained in this manner. Advantageously, the diameter of the nozzle openings is less than 2 mm or less than 1.5 mm. For example, nozzle openings having a diameter of between 0.5 mm and 1.3 mm are chosen. The nozzle openings are preferably arranged tightly, so as to ensure a highly continuous heating. Depending on the size of the nozzle openings, the distance of two adjacent nozzle openings lies between 1 mm and 4 mm.

In a preferred embodiment of the invention, the heating device includes the burner or the burners having an output of between 50 and 500 kW. Typically, the output of one burner is between 30 and 150 kW. Depending on the demands, one or a plurality of burners is installed. The output of the burner or of the burners is distributed to a plurality of nozzle openings, so that the burner output for each nozzle opening remains relatively low, and a local heating of the blank, which is too high, is thus avoided.

A corresponding plant advantageously further encompasses at least one loading device for loading the plant with the blanks and/or at least one transfer device for transferring the blanks into at least one pressing device of the plant. By means of corresponding devices, an operation of a corresponding plant is made possible, which can take place with much quicker clock cycles due to the efficient preheating by means of the pre-mixing hydrogen-oxygen burner proposed according to the invention, because the limiting step of a corresponding method, namely the preheating of the blanks, is reduced significantly with regard to time.

Advantageously, the at least one main heating device, in particular the austenitization device, includes at least one paternoster furnace. Vertical paternoster furnaces, for example, which encompass an improved energy efficiency and which in particular provide the advantage of being able to replace common roller hearth furnaces, which, as mentioned, are of a large design and which thus require corresponding structural conditions, can be used as paternoster furnaces, which are known in principle. For example, paternoster furnaces can be heated electrically or with fuel and can be operated in corresponding temperature ranges, so that an efficient and reliable heating is ensured.

Advantageously, the main heating device, in particular the austenitization device, of a corresponding plant is equipped for heating the blanks to a temperature of between 750-1,050° C., in particular of between 800-1,000° C., for example of between 850-950° C. Generally, a corresponding austenitization device will heat at least areas of a corresponding blank to a temperature, which lies above an austenitization temperature of the corresponding materials. The temperature, which is used, thus depends on the material, which is used, and can simply be derived by the person of skill in the art from corresponding key figures. As mentioned, the complete austenitization temperature of manganese-boron steels is 850° C., for example. In the event that a workpiece, which was already preheated, is heated further in a corresponding austenitization device, an austenitization can be carried out quickly and in an energy-efficient manner.

As mentioned, in one embodiment, a preheating device according to the invention for an above-explained plant for hot forming blanks, encompasses at least one pre-mixing hydrogen-oxygen burner, which, as explained above, provides significant advantages as compared to other burner types.

Advantageously, a preheating device for preheating blanks is embodied, wherein at least one burner flame of the corresponding burner can be directed to the regions, which are provided for the preheating. A corresponding blank can thus be preheated quickly to a temperature, which lies just below the austenitization temperature. By means of a further heating, for example in a paternoster furnace, as mentioned above, the austenitization temperature can then be exceeded quickly and with little expenditure of energy.

Advantageously, a corresponding preheating device is equipped to preheat the blanks to a temperature of between 450-850° C., in particular of between 600-800° C., for example of between 650-750° C. In another embodiment, the preheating device serves to preheat the blanks to a temperature of between 450° C. and 550° C. Corresponding temperatures are temperatures which lie below a, in particular complete, austenitization temperature of a corresponding material. In the case of the manganese-boron steel, which has already been mentioned several times, the complete austenitization temperature is 850° C. The person of skill in the art can derive corresponding data simply from available key figures of such materials.

Advantageously, a preheating device as explained above is provided with an austenitization device in the form of a structural unit. This provides for compact plants, which have a small design and which can be insulated thermally in a simple manner.

It turned out to be advantageous to provide the preheating device with a housing. The heat losses during the local heating of the blank are reduced in this manner and the degree of efficiency is improved accordingly.

The invention is used for the manufacture of auto body components of motor vehicles, for example the B-pillar of a motor vehicle cell, in a particularly advantageous manner. Particular demands are made to such auto body components in view of hardness, material stability and expansion characteristics. In particular, the blanks used for this purpose are not to be too brittle, because tears can otherwise form in the material in response to the forming processes and welding processes, which are necessary for the manufacture of the auto body components.

The burner or the burners used for the preheating according to the invention produce water or water vapor-containing exhaust gases. When these water-containing exhaust gases reach the downstream main heating device, a considerable dew point occurs in the main heating device, which can lead to an increased portion of diffusible hydrogen in the metallic structure of the blanks. The blanks thus become more brittle and the above-described material tears (“delayed fracture”) can occur.

Provision is thus preferably made for means, which prevent exhaust gas from reaching from the burner or from the burners of the preheating device into the main heating device. In a preferred embodiment, provision is made for this purpose for a suction device for extracting exhaust gas from the housing. For this purpose, the housing encompasses one or a plurality of vents, which are connected to an extraction device. The exhaust gas does not only flow out of the vents, but is removed actively. The vents are not identical with the inlet or outlet opening for feeding or discharging the blank into and out of the housing.

Preferably, the vents are arranged such that a flow, which keeps the exhaust gas away from the outlet opening, is embodied in the housing, so as to prevent that exhaust gas reaches via the outlet opening into the following downstream main heating device. In addition, the outlet opening can be provided with a gas veil, in particular a nitrogen veil. A gas, for example nitrogen, is blown into the housing in the area of the outlet opening, so as to form a gas barrier for escaping exhaust gas. Instead of or in addition to the gas veil, it is also possible to close the outlet opening with a slide, a flap or another mechanical means, so as to prevent the escape of exhaust gas.

It can also be advantageous to provide corresponding protective measures for preventing the escape of exhaust gas for the inlet opening of the housing.

A method for hot forming blanks advantageously includes the loading of the blanks into a plant as explained above, to preheat them to a preheating temperature in a preheating device as explained above, to heat or to austenitize, respectively, the blanks in a main heating device, in particular an austenitization device, as explained above, and to form them in a pressing device by means of pressing. A corresponding pressing method can in particular be a so-called press-hardening method.

Such a method advantageously includes a method for preheating blanks, in the case of which the blanks are heated in a preheating device as explained above to a temperature, which lies below, in particular between 5° and 50°, in particular between 10° and 20°, below the austenitization temperature of the blanks. In the event that the blanks are heated to a temperature, which lies just below the austenitization temperature, said temperature can be reached or exceeded, respectively, very quickly and in an energy-efficient manner in an austenitization device, so as to austenitize corresponding workpieces therein.

The plant according to the invention for hot forming blanks, the device according to the invention for preheating the blanks for such a plant as well as the corresponding methods according to the invention for hot forming and preheating benefit similarly from the above-explained advantages.

The afore-mentioned features and the features which will be explained below, cannot only be used in the respective specified combination, but also in other combinations or alone, without leaving the scope of the instant invention.

The invention is illustrated schematically in the drawings by means of an exemplary embodiment and will be described in detail below with reference to the drawings.

In the Figures, the same elements or elements having the same effect have identical reference numerals, if applicable, and will not be explained again for the sake of clarity.

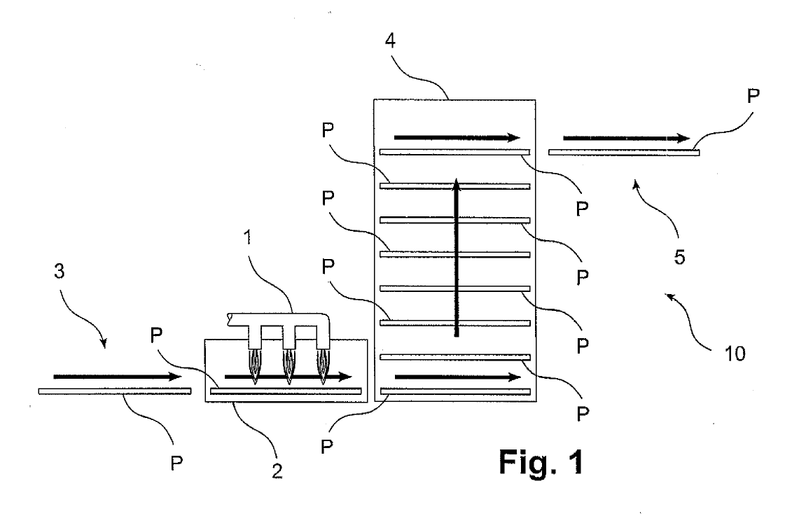

FIG. 1 shows a plant for hot forming blanks according to an embodiment of the invention. The plant as a whole is identified generally as 10. It has a loading device 3, in which corresponding blanks P, for example punched metal sheet pieces, can be loaded into a corresponding plant in an arrow direction. They subsequently pass through a preheating device 2, which encompasses a corresponding burner 1, which is symbolized herein as a three-flamed burner. The burner 1 can encompass any number of burner flames. The burner 1 can also be embodied so as to be mobile and can impact different areas of a blank P consecutively. For this purpose, provision can be made for corresponding movement devices, which can also be controlled fully-automatically, for example, by using a corresponding control. The blanks P pass through the preheating device 2 in arrow direction and are heated there to a temperature, which lies below an austenitization temperature of the corresponding material.

As preferred example for a main heating device, provision is made for an austenitization device 4, which is embodied herein as a schematically illustrated paternoster furnace. The blanks P are introduced into a lower area of the austenitization device 4 in arrow direction, are lifted upwards and are heated continuously during the lifting. With reference to the temperatures used in the austenitization device 4, reference is made to the above information. In an upper area of the austenitization device 4, the blanks P leave in arrow direction.

The blanks P subsequently reach into a transfer device 5 and are transferred there to a pressing tool, for example, which, however, is not illustrated in FIG. 1.

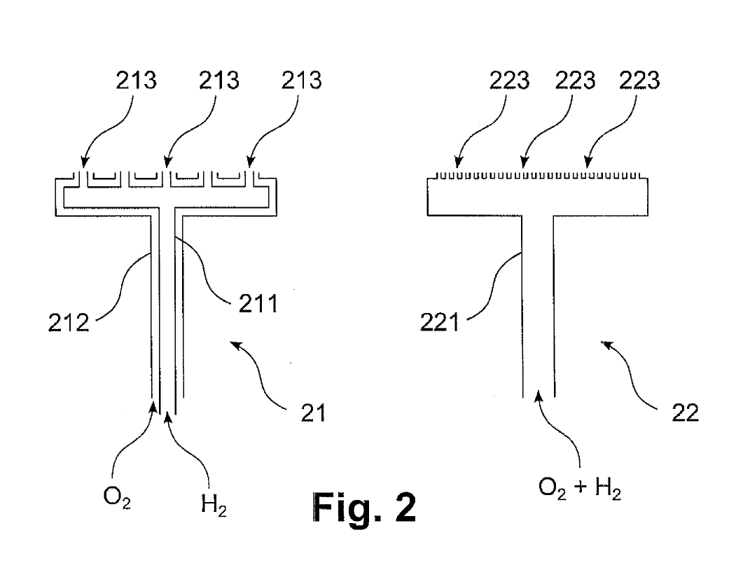

FIG. 2 shows burner heads for being used according to the state of the art, and according to an embodiment of the invention in a schematic illustration, respectively. A so-called externally-mixing burner head is identified as 21, while a pre-mixing burner which can be used according to the invention is identified as 22. For example, the externally-mixing burner head 21 has a line 212 which is located on the outside for providing oxygen, and a line 211 which is located on the inside for providing fuel gas, in particular hydrogen. A mixing of the gases provided via both channels first takes place in the area of burner nozzles 213. As was established, corresponding so-called externally-mixing burners generate relatively soft flames, which are only conditionally suitable for the purposes according to the invention.

In contrast, a much harder burner flame which ensures improved energy transfer can be generated with a pre-mixing hydrogen-oxygen burner, which has a common channel 221 via which a hydrogen-oxygen mixture is supplied to the burner head 22. The corresponding gas mixture already flows out of the nozzles 223 as mixture and is ignited there.

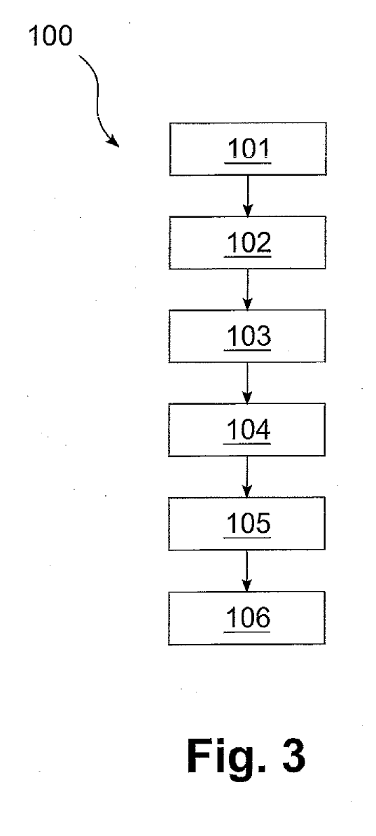

FIG. 3 shows a flow chart of a method of a particularly preferred embodiment of the invention in a schematic illustration. In a first method step 101, corresponding blanks P are punched out of a metal sheet. In a method step 102, they are loaded into a hot forming plant according to the invention, for example by means of a loading device. This can take place continuously. In a step 103, the blanks P are preheated in the plant for the purpose of which the afore-explained means can be used. In a step 104, an austenitization takes place as explained above. After the austenitization, the blanks P are transferred into a pressing tool by means of a transfer device in step 105 and are pressed there in a step 106, for example press-hardened.

What is claimed is:

1. A plant for hot forming blanks, comprising:
at least one preheating device including at least one pre-mixing burner selected from the group consisting of a hydrogen-oxygen burner, a fuel gas-oxygen burner and an acetylene burner; and
at least one main heating device arranged downstream from the at least one preheating device.

2. The plant according to claim 1, further comprising at least one of a loading device for loading the plant with the blanks and at least one transfer device for transferring the blanks into at least one pressing device.

3. The plant according to claim 1, wherein the at least one main heating device comprises at least one paternoster furnace.

4. The plant according claim 1, wherein the at least one main heating device comprises an austenitization device.

5. The plant according to claim 4, wherein the at least one austenitization device is constructed and arranged to heat the blanks to a temperature of from between 750 to 1050° C.

6. A preheating device for a plant for hot forming blanks, comprising:
at least one premixing burner selected from the group consisting of a hydrogen-oxygen burner, a fuel gas-oxygen burner and an acetylene burner; and
at least one main heating device arranged downstream from the premixing burner.

7. The preheating device according to claim 6, wherein the premixing burner is constructed and arranged to preheat the blanks to a temperature of from between 450 to 850° C.

8. The preheating device according to claim 6, wherein the at least one main heating device comprises an austenitization device formed as a structural unit of the plant.

9. The preheating device according to claim 6, wherein the premixing burner comprises a plurality of nozzle openings.

10. The preheating device according to claim 9, wherein the plurality of nozzle openings comprise from 100 to 1000 nozzle openings.

11. The preheating device according to claim 6, wherein the premixing burner comprises a plurality of nozzle openings, wherein each one of the plurality of nozzle openings has a diameter of less than 2 mm, and a distance between adjacent nozzle openings is between from 1 mm to 4 mm.

12. The preheating device according to claim 6, wherein the premixing burner comprises an output of between 50 and 500 kW.

13. The preheating device according to claim 6, further comprising a housing for the premixing burner.

14. The preheating device according to claim 13, wherein the housing comprises a suction device for extracting exhaust gas from the housing.

15. A method for hot forming blanks, comprising:
loading the blanks into a plant having at least one preheating device including at least one pre-mixing burner selected from the group consisting of a hydrogen-oxygen burner, a fuel gas-oxygen burner and an acetylene burner, and at least one main heating device arranged downstream from the at least one preheating device;
preheating the blanks to a preheating temperature in the at least one preheating device to a temperature of from between 450 to 850° C.;
heating the blanks in the at least one main heating device; and
pressing the blanks in a pressing device.

16. The method according to claim 15, wherein the preheating the blanks in the at least one preheating device is to a temperature less than an austenitization temperature of the blanks.
